(19) United States
(12) Patent Application Publication
(10) Pub. No.: US 2009/0259337 A1
(43) Pub. Date: Oct. 15, 2009

(54) Robot Position Calibration Tool (RPCT)

(75) Inventors: George Hilary Harrold, Redding, CT (US); Richard John Johnson, Danbury, CT (US)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Holding N.V., Veldhoven (NL)

(21) Appl. No.: 12/406,546

(22) Filed: Mar. 18, 2009

Related U.S. Application Data
(60) Provisional application No. 61/043,526, filed on Apr. 9, 2008.

(51) Int. Cl. G06F 19/00

(52) U.S. Cl. 700/245; 901/46

(57) ABSTRACT

A Robot Position Calibration Tool (RPCT) is used to accurately calibrate a robot position for a reticle hand-off to a transfer station in a lithography tool with minimized particle generation and outgassing. Method(s), system(s) and computer program product(s) are described to calibrate the robot with minimal sensor usage and minimal slippage of a payload leading to minimized particle generation and outgassing inside a vacuum chamber of a lithography tool.

### CROSS REFERENCE TO RELATED APPLICATIONS

This application claims priority to U.S. Provisional Application No. 61/043,526, filed Apr. 9, 2008, which is incorporated by reference herein in its entirety.

### BACKGROUND

1. Field of the Invention

The present invention relates to an automated robot position calibration tool in a vacuum chamber of a lithography apparatus.

2. Related Art

A lithographic apparatus is a machine that applies a desired pattern onto a substrate or part of a substrate. A lithographic apparatus can be used, for example, in the manufacture of flat panel displays, integrated circuits (ICs) and other devices involving fine structures. In a lithographic apparatus, a robot (interchangeably referred to as “in-vacuum robot” herein) is used to place a reticle inside a vacuum chamber of the lithographic apparatus. To effectively transfer a reticle, the in-vacuum robot has to be accurately calibrated with respect to one or more transfer stations/hand-off positions in the lithography tool such that the reticle has minimum slippage during transfer which will ensure minimized particle generation. Particles in lithographic systems are not desirable as they can alter the pattern being imprinted on the substrate and reduce effective productivity of the tool. Most robot calibration conventionally relies on visual human verification of position. The closest that conventional systems come to automation of robot arm calibration is by physically “touching” an end-effector portion of the robot arm to predefined calibration surfaces within the vacuum chamber. Alternatively, conventional systems that use optical alignment methods use an excessive number of sensors built-in to the robot arm and/or other parts of the lithographic apparatus to align and calibrate the robot.

All of the above-mentioned calibration techniques are undesirable, especially when a low level of particle generation (caused, for example, by contact between an end effector of the robot and a reference surface/transfer station, and slippage resulting from misaligned robot and a reference structure/transfer station), as in Extreme Ultra-Violet (EUV) tools, is desired. Such techniques are also time consuming and limited by their choice of materials within a vacuum environment.

For example, human verification is not very accurate and is inconsistent. In addition, human access to the vacuum chamber is not always possible, and even if access were possible, the access would lead to introduction of undesirable foreign particles in the vacuum chamber, which may cause erroneous/defective manufacturing. Inaccurate alignment can also lead to slippage of a payload, further causing particle generation in the vacuum chamber. Further, due to manufacturing and built-in machine tolerance and resolution limits, it is not possible to have a robot pre-programmed for accurate alignment before the lithography apparatus is assembled.

Various techniques that touch the end-effector to a predefined calibration surface require torque force sensors, which increase complexity and payload of the in-vacuum robot. Physical contact between the end-effector and the calibration surface will cause undesirable particle generation. Further, having additional sensors such as optical alignment inside the vacuum chamber leads to more molecular outgassing in to the vacuum environment that can damage the optics of the lithography apparatus. Strict outgassing requirements also limit the choice of sensor materials, thereby increasing overall manufacturing costs.

### SUMMARY

Therefore, what is needed is a system and method that fully automates in-vacuum robot calibration with minimum impact on the system in terms of particle generation or long term outgassing, that can produce a calibration result that minimizes repeated particle generation due to misalignment during reticle transfer, thereby substantially obviating the drawbacks of the conventional systems. What is also needed is a system and method to perform faster calibrations with minimum or no sensors inside vacuum.

In one embodiment of the present invention, there is provided a system comprising a robot position calibration tool (RPCT). In one example, the RPCT has a substantially same mechanical form factor as an actual payload of the robot (for example, the size of an EUV inner pod and/or a reticle). The RPCT detects how much it has moved relative to the robot during a transfer from the robot to a transfer station corresponding to a hand-off position in the lithography tool. In one example, the RPCT would then, using a transceiver, wirelessly or otherwise, transmit an amount and direction of movement to a controller to determine a new payload hand-off position for the robot. A degree of alignment between the transferred RPCT and the transfer station is calculated. If the RPCT and the transfer station are aligned within acceptable limits, the robot is said to have been calibrated. If not, the RPCT is picked up by the robot from the transfer station, and the robot moves to a new position and the measurements are repeated again. Such a process is carried out until a desired level of alignment between the RPCT as delivered by the robot and a kinematic mount of the transfer station (on which the RPCT rests) is attained. Once the new hand-off position is determined, the Reticle on a baseplate can be transferred to the transfer station such that any slippage of the baseplate, and extraneous particle generated due to such slippage, is minimized.

Additionally, or alternatively, the vectorial distance (e.g., angular, linear or other) moved and the direction of movement of the RPCT, can be calculated by one or more sensors mounted on to the robot. Such sensors present on the robot may be hermetically sealed to avoid outgassing issues, thereby further reducing chances of defects in the final manufactured features on the/a wafer due to extraneous outgassing. Such sensors can be, for example, optical distance measurement sensors, or capacitance gauges.

In another embodiment, there is provided a method comprising exemplary steps for: moving an RPCT residing on an in-vacuum robot to record a first distance reading for a sensor on the robot, after the robot has moved a certain distance, recording a second distance reading, determining how much the RPCT has moved in-plane (e.g., in an x, y, and R_{z} co-ordinate system), determining a difference (offset) between the first and the second distance reading, determining based on the difference, whether the robot is aligned within acceptable limits with respect to a transfer station corresponding to a hand-off position, and storing a final robot hand-off position for future calibrations, thereby minimizing slippage of the RPCT (or any other type of a payload) during a transfer to a kinematic mount of the transfer station.

Additional and alternative embodiments can be used for out of vacuum alignments. Further, by adding additional sensors as and when desired, additional positions can be calibrated, for example, movement of the robot along a z-axis can be performed. For example, sensors can be used to sense when a transfer in a vertical direction (z-axis) occurs. Further still, the techniques, systems and methods of robot arm calibration can be used in conjunction with other conventional techniques well-known to those skilled in the art, to further improvise those conventional techniques. Alternatively, various embodiments of the present invention can be used as stand-alone and independent techniques, systems and methods.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIG. 1 depicts a lithographic apparatus, according to various embodiments of the present invention.

FIG. 2 depicts an in-vacuum robot with multiple transfer stations, according to one embodiment of the invention.

FIG. 3 illustrates the in-vacuum robot in more details, according to one embodiment of the present invention.

FIG. 4A illustrates an elevation view of a payload and corresponding matching pins on an end-effector portion of the in-vacuum robot, according to one embodiment of the present invention.

FIG. 4B illustrates the end-effector portion and a transfer station, according to one embodiment of the present invention.

FIG. 4C illustrates a plan view of the payload, according to one embodiment of the present invention.

FIG. 4D illustrates the transfer station and the end-effector residing on a base plate, according to one embodiment of the invention.

FIGS. 4E-F illustrate a movement of the in-vacuum robot towards a transfer station for calibration purposes during transfer of the payload, according to one embodiment of the present invention.

FIGS. 5A-5B show further details of the RPCT with attached sensors and the end-effector with one or more reference marks, according to one embodiment of the present invention.

FIG. 6 illustrates a flowchart showing steps for calibrating position and movement of the robot arm, according to one embodiment of the present invention.

FIG. 7 illustrates an exemplary computer system used to implement various algorithms, according to one embodiment of the present invention.

One or more embodiments of the present invention will now be described with reference to the accompanying drawings.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

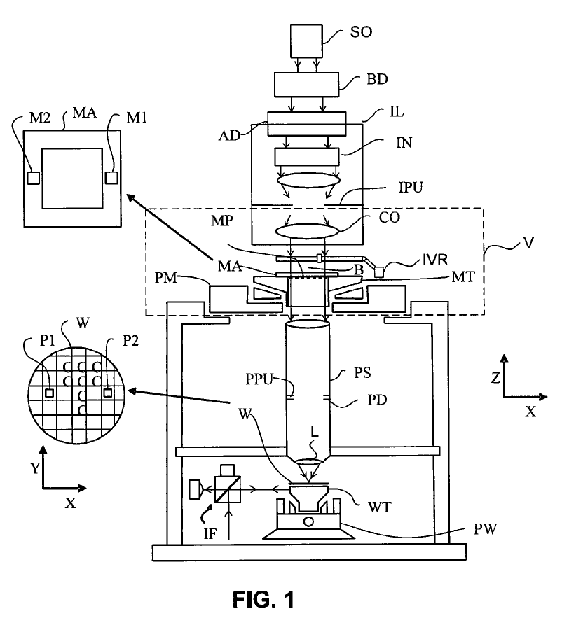

FIG. 1 depicts a lithographic apparatus according to an embodiment of the invention. The apparatus comprises an illumination system IL, a support structure MT, a substrate table WT, and a projection system PS.

The illumination system IL is configured to condition a radiation beam B (e.g., a beam of UV radiation as provided by a mercury arc lamp, or a beam of DUV radiation generated by a KrF excimer laser or an ArF excimer laser, or EUV radiation generated by an EUV source).

The illumination system may include various types of optical components, such as refractive, reflective, and diffractive types of optical components, or any combination thereof, for directing, shaping, or controlling radiation.

The support structure (e.g., a mask table) MT is constructed to support a patterning device (e.g., a mask or dynamic patterning device) MA having a mask pattern MP and connected to a first positioner PM configured to accurately position the patterning device in accordance with certain parameters.

The substrate table (e.g., a wafer table) WT is constructed to hold a substrate (e.g., a resist-coated wafer) W and connected to a second positioner PW configured to accurately position the substrate in accordance with certain parameters.

The projection system (e.g., a refractive projection lens system) PS, including lens L, is configured to project a pattern imparted to the radiation beam B by the pattern MP of the patterning device MA onto a target portion C (e.g., comprising one or more dies) of the substrate W.

The support structure supports, i.e., bears the weight of, the patterning device. It holds the patterning device in a manner that depends on the orientation of the patterning device, the design of the lithographic apparatus, and other conditions, such as for example whether or not the patterning device is held in a vacuum environment. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that may be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern MP includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which may be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, and catadioptric optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g., employing a transmissive mask). Alternatively, the apparatus may be of a reflective type (e.g., employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illumination system IL receives a radiation beam from a radiation source SO. The source and the lithographic apparatus may be separate entities, for example when the source is an excimer laser. In such cases, the radiation beam is passed from the source SO to the illumination system IL with the aid of a beam delivery system BD comprising, for example, suitable directing mirrors and/or a beam expander. In other cases the source may be an integral part of the lithographic apparatus, for example when the source is a mercury lamp. The source SO and the illumination system IL, together with the beam delivery system BD if required, may be referred to as a radiation system.

The illumination system IL may comprise an adjuster AD for adjusting the angular intensity distribution of the radiation beam at mask level. Generally, at least the outer and/or inner radial extent (commonly referred to as cR-outer and CT-inner, respectively) of the intensity distribution in a pupil IPU of the illumination system may be adjusted. In addition, the illumination system IL may comprise various other components, such as an integrator IN and a condenser CO. The illumination system may be used to condition the radiation beam, to have a desired uniformity and intensity distribution in its cross-section at mask level.

The radiation beam B is incident on the patterning device (e.g., mask MA or programmable patterning device), which is held on the support structure (e.g., mask table MT), and is patterned by the patterning device in accordance with a pattern MP. Having traversed the mask MA, the radiation beam B passes through the projection system PS, which focuses the beam onto a target portion C of the substrate W.

The projection system has a pupil PPU conjugate to the illumination system pupil IPU, where portions of radiation emanating from the intensity distribution at the illumination system pupil IPU and traversing a mask pattern without being affected by diffraction at a mask pattern create an image of the intensity distribution at the illumination system pupil IPU.

With the aid of the second positioner PW and position sensor IF (e.g., an interferometric device, linear encoder or capacitive sensor), the substrate table WT may be moved accurately, e.g., so as to position different target portions C in the path of the radiation beam B. Similarly, the first positioner PM and another position sensor (which is not explicitly depicted in FIG. 1) may be used to accurately position the mask MA with respect to the path of the radiation beam B, e.g., after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these arc known as scribe-lane alignment marks). Similarly, in situations in which more than one die is provided on the mask MA, the mask alignment marks may be located between the dies.

Mask table MT and patterning device MA can be in a vacuum chamber V, where an in-vacuum robot IVR can be used to move patterning devices such as a mask, similar to patterning device MA, in and out of vacuum chamber V. Alternatively, when mask table MT and patterning device MA are outside vacuum chamber V, an out-of-vacuum robot can be used for various transportation operations, similar to the in-vacuum robot IVR. Both the in-vacuum and out-of-vacuum robots need to be calibrated for a smooth transfer of any payload (e.g., mask) to a fixed kinematic mount of a transfer station.

The depicted apparatus could be used in at least one of the following modes:

1. In step mode, mask table MT and the substrate table WT are kept essentially stationary, while an entire pattern imparted to the radiation beam is projected onto a target portion C at one time (i.e., a single static exposure). Substrate table WT is then shifted in the X and/or Y direction so that a different target portion C may be exposed. In step mode, the maximum size of the exposure field limits the size of the target portion C imaged in a single static exposure.

2. In scan mode, mask table MT and the substrate table WT are scanned synchronously while a pattern imparted to the radiation beam is projected onto a target portion C (i.e., a single dynamic exposure). The velocity and direction of substrate table WT relative to mask table MT may be determined by the (de-)magnification and image reversal characteristics of projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, mask table MT is kept essentially stationary holding a programmable patterning device, and substrate table WT is moved or scanned while a pattern imparted to the radiation beam is projected onto a target portion C. In this mode, generally a pulsed radiation source is employed and the programmable patterning device is updated as required after each movement of substrate table WT or in between successive radiation pulses during a scan. This mode of operation may be readily applied to maskless lithography that utilizes a programmable patterning device, such as a programmable mirror array of a type as referred to above.

Combinations and/or variations on the above described modes of use or entirely different modes of use may also be employed.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm).

Prior to, as well as after a lithographic operation, an in-vacuum robot is used to place or position an object (e.g., a reticle) inside a vacuum chamber of the lithographic apparatus. To place the object with minimum slippage, the in-vacuum robot has to be calibrated accurately for each transfer station.

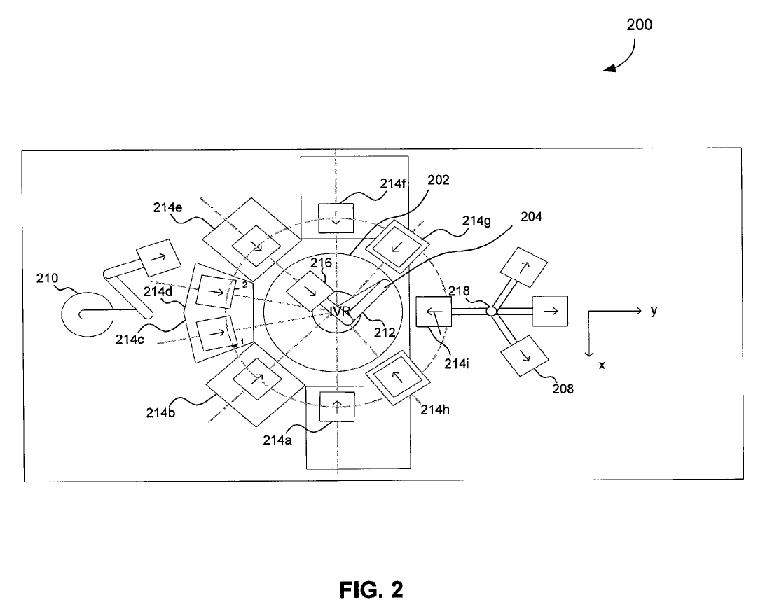

FIG. 2 illustrates an exemplary overall setup 200 for in-vacuum calibration using an in-vacuum robot (IVR) 204, according to one embodiment of this invention. Setup 200 shows a vacuum chamber 202, in-vacuum robot 204 with a robot arm 212, a reticle exchange robot 218 that transfers objects 216 (e.g., reticles) in and out of vacuum chamber 202 through transfer stations 214a-i, and an out of vacuum robot 210.

Using various embodiments of the present invention, robot arm 212 is calibrated for various transfer positions. Such a calibration can be performed anytime. For example, calibration can be performed before each object 216 (also interchangeably referred to herein as payload 216 or reticle 216) is moved inside vacuum chamber 202, or can be performed at predetermined, periodic, or random intervals, as and when needed, or additionally and/or alternatively during idle states of the lithographic apparatus. It is to be noted that the term “payload” generally refers to any object that is picked up and placed by the in-vacuum or out-of vacuum robot(s).

Inside vacuum chamber 202, robot arm 212 moves reticle/object 216 and transfers it to one of transfer stations 214a-i, via an end-effector portion (not shown in FIG. 2) of robot arm 212 for various lithography operations. It is to be noted that the term “transfer station” in the lithography tool described herein generally refers to any position where object 216 can be placed upon or handed-off to a corresponding kinematic mount of transfer stations 214a-i. To minimize slippage during transfer of reticle 216 onto the end effector, in-vacuum robot 204 should be accurately aligned to the transfer station(s) 214a-i inside vacuum chamber 202. In-vacuum robot 204 can perform such a transfer operation from multiple exchange positions corresponding to the locations of transfer station 214a to 214i (although any number of object/reticles and any number of corresponding transfer stations can be used). Therefore, in-vacuum robot 204 is controlled to allow for robot arm 212 to perform a smooth, low slippage transfer and alignment of the objects/reticles 216 onto transfer stations 214a-i inside vacuum chamber 202.

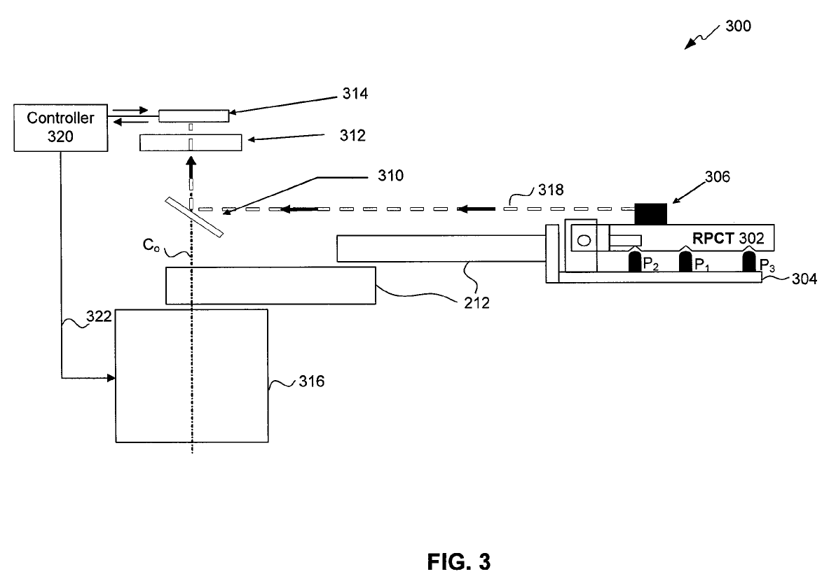

FIG. 3 illustrates an in-vacuum robot 300 (similar to in-vacuum robot 204), according to an embodiment of the present invention. In-vacuum robot 300 rotates about a central axis of rotation C₀, around which a robot base 316 is built. Robot arm 212, or sub-components and portions thereof, can move along one or more axes/directions about central axis of rotation C₀ or other local axes/directions. Robot base 316 is connected to robot arm 212. Robot arm 212 comprises an end effector portion 304 which can hold the robot position calibration tool (RPCT) 302 or a reticle on a carrier.

In one example, end-effector portion 304 may have pins, e.g., pins P1, P2, P3.

In one example, RPCT portion 302 is coupled to an infrared wireless transceiver 306 (also interchangeably referred to as transceiver 306 herein). Wireless transceiver 306 transmits distance and movement data to a detector/reader 314 by means of a communication signal 318. In the example shown, signal 318 reflects off mirror 310 and passes through a window 312 in vacuum chamber 202 before being received by detector/reader 314. It is to be appreciated in other embodiment, signal 318 may be received directly at detector/reader 314, or through other signal paths, as would be understood by a skilled artisan.

If needed, based on position data transmitted by wireless transceiver 306, a position of robot arm 212 and consequently, components thereof (e.g., RPCT 302 and end effector portion 304), is altered and/or adjusted, so as to accurately align end effector 304, or RPCT portion 302 with respect to a transfer station (not shown). Referring also to FIG. 2, this can allow for a better transfer of payload 216, held by robot arm 212, to the transfer station 220 inside vacuum chamber 202 during normal lithography operations, after in-vacuum robot 204 has been calibrated.

Additionally, or alternatively, it is to be noted that although a wireless transceiver 306 is being described herein, other types of transceivers well known to one skilled in the art, such as transceivers communicating via a wired communication channel, infrared, radio-frequency channel, etc., can also be used. It is also to be noted that in the embodiment described in FIG. 3, if transceiver 306 is a radio-frequency (RF) transceiver, then signal 318 does not need to follow the path shown, but can be transmitted wirelessly through any other path depending upon a particular type of antenna being used in transceiver 306. In such a scenario where an RF transceiver is being used, mirror 310 is not needed. Further, the RF transceiver can communicate with controller 320 by establishing an RF link by standard technique(s) well known to those skilled in the art.

Once position data associated with various parts of robot arm 212 reaches detector/reader 314, the position data is processed using a controller 320. Controller 320 determines a desired position of RPCT 302 based on the data. In one example, the controller 320 runs one or more software algorithms to accurately determine a desired subsequent relative position of end-effector portion 304 using RPCT 302 for a hand-off of a reticle/object 216 at a kinematic mount of any of transfer stations 214a-i. Data corresponding to the desired subsequent relative position is transmitted as a feedback signal 322 to in-vacuum robot 204, which adjusts the position of robot arm 212 by moving robot arm 212 along one or more directions. Additionally, or alternatively, alignment of transfer stations 214a-i and end-effector portion 304 may occur in a single step or may be repeated to meet a desired degree of accuracy.

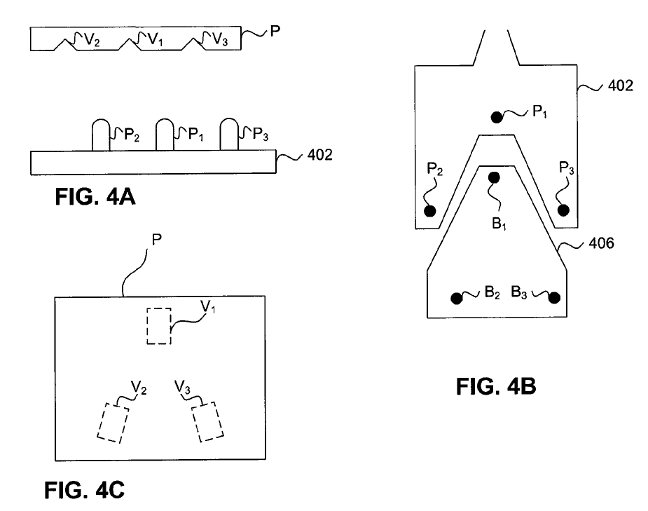

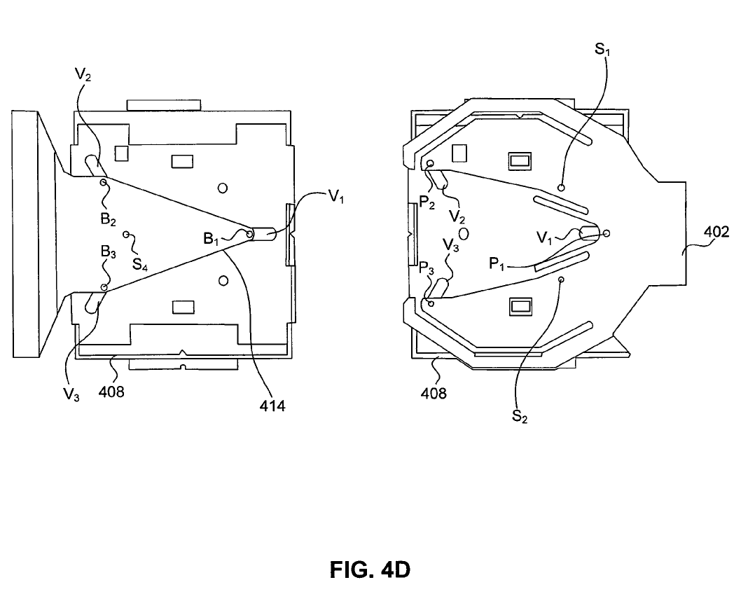

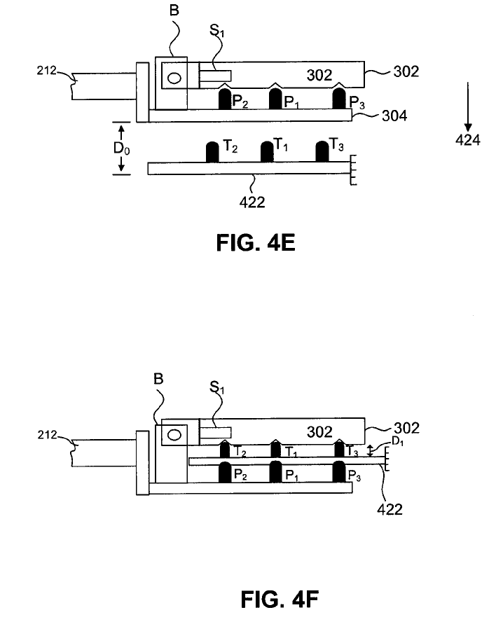

FIG. 4C shows a plan view of payload P. It is to be noted that during calibration operations, payload P is the same as RPCT 302. However, for sake of a simpler description, a generic term “payload” (defined earlier) is being used herein. Payload P comprises three V shaped notches or niches shown as V1, V2, and V3. It is to be noted that although V-shaped notches are shown, other types of kinematic mounts, e.g., cone-flat-V, can also be used. Corresponding to these three V shaped niches V1, V2, and V3 (shown in an elevation view in FIG. 4A) are complementary pins P1, P2, and P3 extending from end-effector 402, as also shown in FIG. 4A. After calibration, the three V shaped notches V1, V2, and V3 of payload P fit with a set of matching pins B1, B2, and B3 of a kinematic mount of a transfer station (shown in FIG. 4B). Similarly, during another calibration operation, the V shaped notches of payload P fit within a capture range or a threshold level of a match with respect to pins P1, P2 and P3 of end effector 402, thereby accurately aligning payload P with end-effector 402.

FIG. 4B illustrates end-effector 402 and a transfer station 406, which may be inside a vacuum chamber (not shown). According to one embodiment of the present invention, end-effector 402 has a payload (e.g., RPCT 302) residing on it, before being transferred to transfer station 406. End-effector 402 comprises three ball pins P1, P2, P3 that hold a payload (not shown) and transfer the payload onto transfer station 406 via corresponding ball pins B1, B2, B3 on transfer station 406. Shapes of pins P1, P2, and P3 (and, B1, B2, B3) and their corresponding niches on the payload are design choices well known to those skilled in the art. An exemplary structure of a payload and an end-effector are shown in U.S. Pat. No. 7,004,715, entitled “Apparatus for Transferring and Loading a Reticle with a Robotic Reticle End-Effector,” which is incorporated by reference herein in its entirety.

FIG. 4D illustrates transfer station 414 and end-effector 402 residing on a base plate 408, according to one embodiment of the invention. FIG. 4E shows a bottom of a base plate 408, according to one embodiment of the present invention. FIGS. 4F-G a base plate 408 with and without reticle 216 residing on it, according to one embodiment of the invention.

FIG. 4D further illustrates how ball pins B1, B2, and B3 locate V-shaped notches on a base-plate 408, which is configured to carry a reticle. As can be seen from FIG. 4D, V-shaped notches prevent movement in a plane (not shown) parallel to base plate 408. Similarly, FIG. 4D also shows end-effector portion 402 latching on to the V-shaped notches V1, V2, and V3 of base plate 408 via pins P1, P2, and P3. The elongated shape of the V-shaped notches is shaped to accommodate both transfer station 414 (similar to any of transfer stations 214a-i) and end-effector portion 402. RPCT 302 (not shown in FIG. 4D, but see FIG. 3) measures angular (R_{z}) and horizontal (x,y) misalignment of transfer station 414 and end-effector portion 402 with respect to each other, and accordingly calibrates robot 204 with end effector 402 to the position of transfer station 414. Additional sensors could be added to measure vertical distance allowing calibration of handoff elevation.

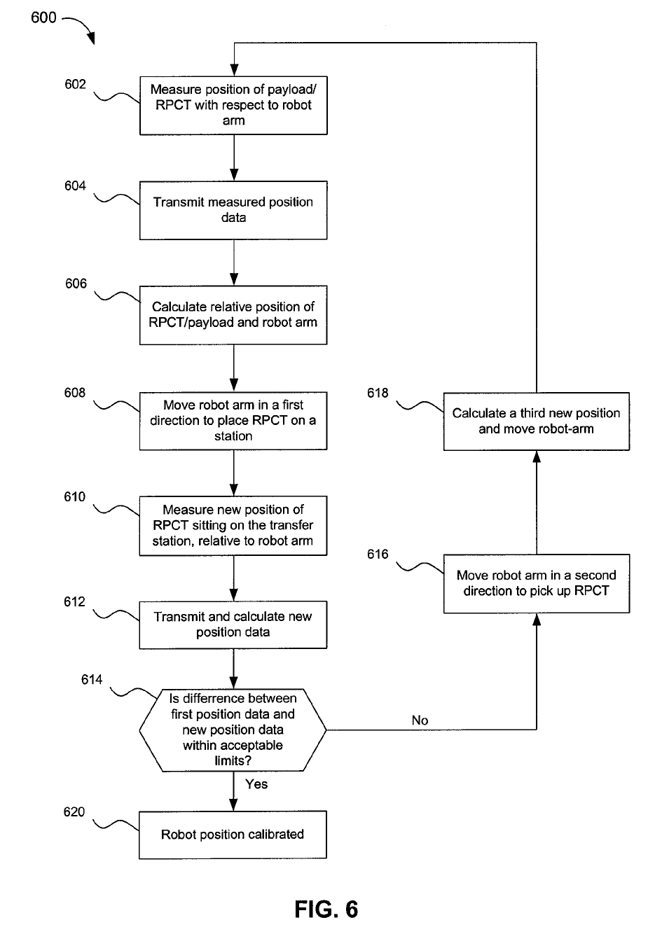

FIGS. 4E and 4F illustrate in further detail how RPCT 302 is moved by robot arm 212 (shown in part) to determine a calibrated hand-off position of the robot, according to one embodiment of the present invention. FIG. 4E illustrates a transfer station kinematic mount 422 corresponding to the hand-off position below end-effector 304 kinematic mount holding RPCT 302. RPCT 302 measures distance from sensors S1, S2, S3 to reference block B on robot end-effector 304 when a calibration process (described below in FIG. 6) begins at time t₀. RPCT 302 is moved towards transfer station kinematic mount 422 in a direction shown by arrow 424 such that RPCT 302 transfers from end-effector 304 kinematic mount to transfer station kinematic mount 422. As shown herein, transfer station kinematic mount 802 has pins T₁, T₂, and T₃ resident on one of its surfaces to spatially match with the notches of RPCT 302.

FIG. 4F illustrates a second time instance t₁ when RPCT 302 has been transferred to transfer station kinematic mount 422. RPCT 302 takes a second measurement of its position with respect to reference block B and transmits the measured position data to an external controller. In this embodiment, sensors S1, S2, S3 can be used to determine position in x, y, R_{z} of a coordinate system such as would be needed to minimize sliding and thus particle generation during transfer from one ball and V to another ball and V of kinematic mount. The difference between the measurement at time t₀ and time t₁ are used to determine if calibration of robot transfer position in x, y, Rz are within acceptable limits and the process continues as illustrated in FIG. 6.

Once accurate calibration has been performed, and associated position and movement data corresponding to robot arm 212 has been determined, payload P can be effectively transferred from end-effector 304 kinematic mount to transfer station kinematic mount 802 with minimized sliding.

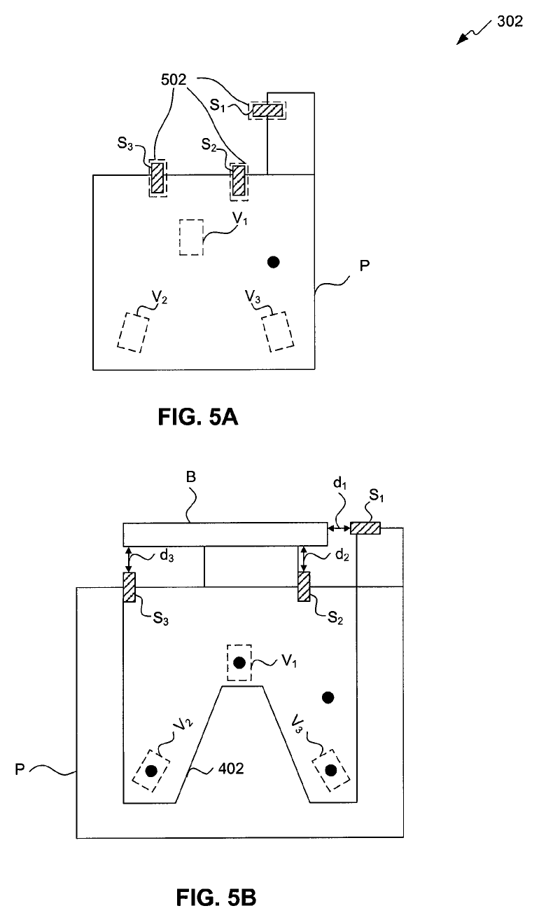

FIG. 5A further illustrates payload P in more detail, according to one embodiment. In addition to the V shaped niches V1, V2, and V3, payload P also has sensors S1, S2, and S3 that measure distance to a reference block B on end-effector portion 402 of an in-vacuum robot (not shown) and internally transmit it to transceiver 306 (not shown), to which sensors S1, S2, and S3 are coupled. Additionally, or alternatively, although sensors S1, S2, and S3 are shown coupled to payload P, they can be placed anywhere on an in-vacuum robot arm (not shown). Further, sensors S1, S2, and S3 can be permanently fixed to the in-vacuum robot arm or can be replaceable, depending on specific applications. Sensors S1, S2, and S3 can be motion sensors, position sensors, or other types of sensors. In order to minimize contamination in a vacuum chamber (not show) due to accidental or natural leakage/outgassing of sensors S1, S2, and S3, sensors S1, S2, and S3 can be placed on the in-vacuum robot arm in a hermetically sealed package 502 or placed on RPCT 302 which will spend limited time in the vacuum environment and thus limit outgassing, to the vacuum system.

It should be apparent to one skilled in the art, that although three sensors S1, S2, and S3 are shown, depending on specific needs, position/motion data can also be recorded using only one sensor or, alternatively, more than three sensors.

FIG. 5B illustrates a bottom view of a superposition of payload P and end-effector 402. For example, with reference to FIG. 3, this may occur during a hand-off of RPCT 302 to transfer station 406. As shown in FIG. 5B, V-shaped notches V1, V2, V3 correspond with pins (not shown) on end-effector 402 and pins P1, P2, P3. End-effector 402 can have a reference mark, such as a block B, for example, to aid RPCT portion 302 in a better measurement of position with respect to end-effector portion 402. Additionally sensors S1, S2, and S3 can be strategically placed to assure that distance measurements made correspond to 3 degrees of freedom, in this case X, Y and R_{z}. Additional sensors could be added to measure an elevation Z. For example, in the embodiment shown in FIG. 5B, sensors S1, S2, and S3 measure distances d1, d2, and d3, respectively from reference block B. Adjustments in calibrated robot position during transfer to transfer stations 214a-i will minimize particle generation inside vacuum chamber 202 due to slippage between payload P and end-effector portion 402 as well as payload P and transfer station 406 during an exchange of the payload from ball pins P1, P2, P3 to ball pins B1, B2, B3.

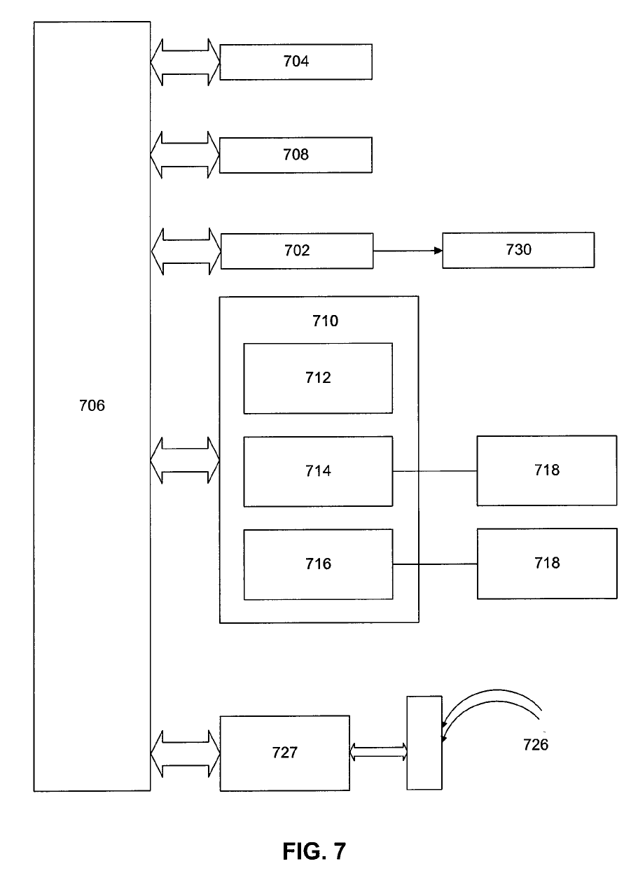

FIG. 6 is a flowchart depicting a method 600 showing steps to implement an exemplary embodiment of the present invention. Steps 602-616 do not necessarily have to be performed in the order shown, and can be performed in any order depending on specific needs. In one example, method 600 is performed using one or more of the systems described above in FIGS. 1-5B and below in FIGS. 7 and 8A-B.

In step 602, using one or more sensors, a position of an RPCT with respect to the robot arm position, including an end-effector portion is measured. It is to be noted that position (or motion in some embodiments) can be measured in Cartesian, cylindrical, spherical, or any other generalized co-ordinate system well known to those skilled in the art.

In step 604, recorded position data corresponding to the RPCT with respect to the robot arm is transmitted, wirelessly or otherwise, to an external controller by a transceiver. Although described as being wirelessly transmitted, as discussed above, other transmission techniques may also be used.

In step 606, the external controller determines or calculates relative position of the RPCT held by the in-vacuum robot arm end-effector portion 304. The transmitted position and movement data is used as inputs to one or more software algorithm implementations/routines recorded on the controller to determine position of the RPCT with respect to the robot arm in the desired coordinates.

In step 608, the robot arm is moved vertically down so as to transfer the RPCT to a transfer station inside the vacuum chamber.

In step 610, position data corresponding to the new position of the RPCT sitting on the transfer station is measured, relative to the robot arm.

In step 612, the new measured position data is transmitted to the external controller, and further calculations are made by the external controller about the new position of the RPCT, including how much the RPCT has moved in-plane.

In step 614, a decision is made by the external controller whether the difference between the first position data and the new position data (relative alignment) is within acceptable limits. If not, the external controller sends back a feedback signal to the in-vacuum robot to pick up the RPCT (as shown in step 616). Next a new transfer position is calculated based on the relative alignment. The robot then performs steps 602-616 again until the difference of position measured before and after transfer to the transfer station between the RPCT and the robot is within acceptable limits. Such calculations made by the external controller can include optimization techniques well known to those skilled in the art.

If the alignment is within an acceptable range, at step 620 the robot positions are recorded as calibrated to effectively transfer subsequent payloads with minimum slippage.

In one example, after the robot arm positions have been calibrated, and after the payload (e.g., mask) is transferred to the transfer station, the in-vacuum robot is ready to perform reticle transport as needed to support lithography operations.

Additionally, or alternatively, steps 602-616 and portions thereof can be performed for multiple hand-off positions of the in-vacuum robot, for example, as described earlier with respect to FIG. 2.

FIG. 7 illustrates an exemplary computer system 700 to implement various controller operations and/or software algorithms. Embodiments of the present invention may also be implemented using hardware, software, firmware, or a combination thereof, and may be implemented in one or more computer systems or other processing systems. However, the manipulations performed by the present invention were often referred to in terms, such as comparing or checking, which are commonly associated with mental operations performed by a human operator. No such capability of a human operator is necessary, or desirable in most cases, in any of the operations described herein, which form a part of the present invention. Rather, the operations are machine operations. Useful machines for performing the operations in the present invention may include general-purpose digital computers or similar devices.

In fact, in accordance with an embodiment of the present invention, the present invention is directed towards one or more computer systems capable of carrying out the functionality described herein.

An example of the computer systems includes a computer system 700, which is shown in FIG. 7. Computer system 700 includes one or more processors, such as a processor 704. Processor 704 is connected to a communication infrastructure 706, for example, a communications bus, a cross over bar, a network, and the like. Various software embodiments are described in terms of this exemplary computer system 700. After reading this description, it will become apparent to a person skilled in the relevant art(s) how to implement the present invention using other computer systems and/or architectures.

Computer system 700 includes a display interface 702 that forwards graphics, text, and other data from communication infrastructure 706 (or from a frame buffer which is not shown in FIG. 7) for display on an I/O device or display 730. Computer system 700 also includes a main memory 708, such as random access memory (RAM), and may also include a secondary memory 710. Secondary memory 710 may include, for example, a hard disk drive 712 and/or a removable storage drive 714, representing a floppy disk drive, a magnetic tape drive, an optical disk drive, etc. Removable storage drive 714 reads from and/or writes to a removable storage unit 718 in a well known manner. Removable storage unit 718 represents a floppy disk, magnetic tape, optical disk, and the like. Removable storage unit 718 may be read by and written to by removable storage drive 714. As will be appreciated, removable storage unit 718 includes a computer usable storage medium having stored therein, computer software and/or data.

In accordance with various embodiments of the present invention, secondary memory 710 may include other similar devices for allowing computer programs or other instructions to be loaded into computer system 700. Such devices may include, for example, a removable storage unit such as removable storage unit 718, and an interface 716. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from removable storage unit 718 to computer system 700.

Computer system 700 may also include a communication interface 727. Communication interface 727 allows software and data to be transferred between computer system 700 and external devices. Examples of communication interface 727 may include a modem, a network interface (such as an Ethernet card), a communications port, a Personal Computer Memory Card International Association (PCMCIA) slot and card, and the like. Software and data transferred via communication interface 727 are in the form of a plurality of signals, which may be electronic, electromagnetic, optical or other signals capable of being received by communication interface 727. Signals are provided to communication interface 727 via a communication path (e.g., channel) 726. Communication path 726 carries these signals and may be implemented using wire or cable, fiber optics, a telephone line, a cellular link, a radio frequency (RF) link and other communication channels.

In this document, the terms “computer program medium” and “computer usable medium” are used to generally refer to media such as removable storage drive 714, a hard disk installed in hard disk drive 712, signals, and the like. These computer program products provide software to computer system 700. The present invention is directed to such computer program products.

Computer programs (also referred to as computer control logic) are stored in main memory 708 and/or secondary memory 710. Computer programs may also be received via communication interface 727. Such computer programs, when executed, enable computer system 700 to perform the features of the present invention, as discussed herein. In particular, the computer programs, when executed, enable processor 704 to perform the features of the present invention. Accordingly, such computer programs represent controllers of computer system 700.

In accordance with an embodiment of the present invention, where the present invention is implemented using software, the software may be stored in a computer program product and loaded into computer system 700 using removable storage drive 714, hard disc drive 712 or communication interface 727. The control logic (software), when executed by processor 704, causes processor 704 to perform the functions of the present invention as described herein.

In another embodiment, the present invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the present invention is implemented using a combination of both the hardware and the software.

Although specific reference is made above to the use of embodiments of the invention in the context of optical lithography, it will be appreciated that the invention can be used in other applications, for example imprint lithography, where the context allows, and is not limited to optical lithography. In imprint lithography a topography in a patterning device defines the pattern created on a substrate. The topography of the patterning device can be pressed into a layer of resist supplied to the substrate whereupon the resist is cured by applying electromagnetic radiation, heat, pressure or a combination thereof. The patterning device is moved out of the resist leaving a pattern in it after the resist is cured.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

What is claimed is:

1. A system for calibration of an in-vacuum robot, comprising:
a robot arm including an end-effector portion with a robot position calibration tool (RPCT) portion residing on the end-effector portion;
a sensor coupled to the robot arm and configured to determine:
a first distance from the end-effector portion to the RPCT portion while held by a kinematic mount of the end-effector and
a second distance from the end-effector portion to the RPCT portion while held by a kinematic mount of a transfer station;
a transceiver coupled to the sensor and configured to transmit a signal representing the determined distance and position information; and
a controller configured to determine a new robot handoff position based on a relative movement information transmitted in the signal.

2. The system of claim 1, wherein the transceiver is a wireless transceiver.

3. The system of claim 2, wherein the wireless transceiver is at least one of a radio frequency transceiver and an infrared transceiver.

4. The system of claim 1, wherein the sensor is configured to determine a direction of movement of the RPCT.

5. The system of claim 1, wherein the sensor is configured to determine a relative distance of movement between the RPCT and the robot arm.

6. The system of claim 1, wherein the sensor is sealed hermetically, thereby avoiding outgassing into a vacuum environment.

7. The system of claim 1, wherein the sensor comprises a replaceable distance sensor coupled to at least one of the end-effector portion of the robot arm and/or the RPCT portion.

8. The system of claim 1, wherein the end-effector portion has a reference mark for alignment purposes.

9. The system of claim 1, further comprising:
an illumination system configured to produce a beam of radiation;
a patterning device configured to pattern the beam of radiation, which is located in the vacuum chamber; and
a projection system configured to project the patterned beam onto a target portion of a substrate,
wherein the robot is configured to move the patterning device within the vacuum chamber.

10. The system of claim 1, wherein the sensor is configured to determine a new position of the RPCT with respect to the transfer station, after the robot has moved to a new position.

11. A method for calibrating a robot in a vacuum chamber of a lithography tool, comprising:
determining a first position of a robot position calibration tool (RPCT) with respect to the robot resulting in a first distance;
moving the robot vertically to transfer the RPCT to a second position on a transfer station kinematic mount resulting in a second distance corresponding to the second position;
wirelessly transmitting the first and the second distance to a controller;
calculating an offset based on a difference between the first and the second distance moved by the RPCT during a transfer to the transfer station; and
moving the robot arm to a new position and measuring a new distance, based on a feedback signal from the controller, whereby the new position determines a calibrated position of the robot.

12. The method of claim 11, further comprising repeating the determining, moving, transmitting, and moving one or more times to meet a threshold level of alignment between the RPCT and the transfer station.

13. A method for transferring an object in a vacuum chamber of a lithography tool, comprising:
detecting a first position of the object carried by a robot in the vacuum chamber;
detecting a second position of a kinematic mount of a transfer station to which the object has to be transferred;
determining relative positions of the object and the transfer station;
wirelessly transmitting the relative positions to a controller;
receiving a feedback signal from the controller to accurately align the robot carrying the object with respect to the transfer station;
calibrating a position of the robot based on the feedback signal; and
transferring the object to the transfer station after the calibrating.

14. The method of claim 13, wherein the calibrating comprises moving the robot along at least one axis to result in a new position of the robot.

15. The method of claim 13, wherein the transferring comprises transferring the object from the robot to a transfer station corresponding to a hand-off position.

16. The method of claim 13, wherein the detecting the first position comprises determining a distance between the object and the transfer station.

17. The method of claim 13, further comprising: repeating the detecting the first and second positions, the determining, the transmitting, the receiving, and the calibrating one or more times after the transferring, whereby particle generation due to slipping of the object is minimized.

18. A computer readable medium having a computer program logic recorded thereon for controlling at least one processor, the computer program logic comprising:
first computer program code means for detecting a first position of a robot carrying a calibration tool;
second computer program code means for detecting a second position of a kinematic mount of a transfer station to which the calibration tool has to be transferred;
third computer program code means for determining a relative position of the calibration tool and the transfer station;
fourth computer program code means for wirelessly receiving data about the relative position to a computer;
fifth computer program code means for transmitting a feedback signal to accurately align the relative position of the robot carrying the calibration tool with respect to the transfer station;
sixth computer program code means for calibrating the transferred position of the robot carrying the based on the feedback signal; and
seventh computer program code means for transferring the calibration tool to the transfer station.

19. A tangible computer-readable medium containing instructions that, when executed by a processor, cause the processor to:
produce first distance data of a robot position calibration tool with respect to a robot inside a vacuum chamber of a lithography tool;
move the robot vertically towards a transfer station inside the vacuum chamber to produce second distance data;
wirelessly transmit the first and the second distance data to a controller;
calculate an offset based on a difference between the first and the second distance data;
wirelessly receive a feedback signal from the controller based on the calculated offset; and
adjust, based on the feedback signal, the robot to a new position to produce a calibrated position of the robot.

20. A computer readable storage medium having embodied thereon computer program code executable by a processor for calibrating a hand-off position of an object in a lithography tool, the computer readable storage medium comprising:
first computer program code that enables the processor to produce first position data of a robot;
second computer program code that enables the processor to wirelessly transmit the first position data to a controller;
third computer program code that enables the processor to wirelessly receive a feedback signal from the controller based on the transmitted first position data; and
fourth computer program code that enables the processor to adjust, based on the feedback signal, a first position of the robot to a second position of the robot, wherein the second position is a calibrated position.
